(19) United States
(12) Patent Application Publication
(10) Pub. No.: US 2005/0097449 A1
(43) Pub. Date: May 5, 2005

(54) System and method for content structure adaptation

(76) Inventors: Jurgen Lumera, Fahrenzhausen (DE); Karen Lease, Versailles (FR)

Correspondence Address: BAKER & HOSTETLER LLP, Washington Square, Suite 1100, 1050 Connecticut Avenue, N.W., WASHINGTON, DC, 20036, US

(21) Appl. No.: 10/738,997

(22) Filed: Dec. 19, 2003

Related U.S. Application Data
(63) Continuation-in-part of application No. 10/697,873, filed on Oct. 31, 2003.

(51) Int. Cl. G06F 17/21; G06F 17/24

(52) U.S. Cl. 715/511

(57) ABSTRACT

A system for content structure adaptation is provided that includes a grammar specification that defines a set system rules, a descriptor that defines content names and types, where the descriptor creates an instance based upon the grammar specification, an interpreter that adds system requirements to the instance, and a code generator that generates application code in response to the system requirements defined in the instance. A method for content structure adaptation includes deriving a data element description from common data, applying system rules to the data element description to create an instance that includes data element definitions and system data requirements, and mapping the data element definitions to corresponding source code fragments in response to the system data requirements. The content structure adaptation system and method changes the data structure of a documentation system by editing a configuration file, as opposed to manually reconfiguring or rewriting source code.

### PRIORITY

This application is a continuation-in-part of pending U.S. Patent Application entitled “Network System For Information Creation, Management and Publication of Documentation” filed Oct. 31, 2003 having Ser. No. 10/697,873, the disclosure is hereby incorporated by reference.

### FIELD OF THE INVENTION

The present invention relates generally to a system for information creation, management and publication of documentation. More particularly, the present invention relates to a system and method for content structure adaptation in an information management system.

### BACKGROUND OF THE INVENTION

Over the past few years, many companies have expended considerable resources on the creation, management and publication of documentation associated with products or services. This is at least partially due to the volume of technical documentation that is used in product manufacturing, as well as the considerable volume of information that is necessary to operate and service a given product, be it a toaster oven or an automobile. While a great deal of the creation, management and publication of documentation (hereinafter “the documentation lifecycle”) takes place in electronic form, the efficiencies companies thought would be achieved by storing the information electronically has not been realized.

The adoption and use of electronic authoring, storage and publishing technology has made information available in a variety of new formats in addition to printed publications. Generally, publication of information into an electronic format has improved access to useful information by making it more immediate and more widely available. One area where this can be seen is in the area of documentation. An example of this can be appreciated in that it is possible to access documentation such as a VCR user's guide by visiting the VCR manufacturer's website irrespective of the time of day or location of the user. However, the adoption and use of electronic authoring, storage and publication technology as has been done in prior systems, has, in and of itself, not provided the ability to effectively manage and control this information. Prior documentation systems have and do not provide the ability to create, manage and publish documentation from a single source of information. Additionally, prior documentation systems do not enable one to effectively to re-use information.

As previously mentioned “the documentation lifecycle” can be described to include the stages of creation, management and publication of information. Previous documentation systems have generally followed one of two approaches. The first approach involves manual coordination between a number of separate applications used at each stage of the documentation cycle. The second approach has been to use an all-in-one documentation system from a single vendor.

The first approach of previous systems involves manual coordination between separate applications used at each stage of the documentation lifecycle. A typical documentation approach may include, technical writers to create/edit information, an information technology (IT) department to handle the management and storage of the information, and a third party to publish the documentation into one or more formats. It is also likely that the technical writers will use one or more applications to create/edit information, the IT department will use one or more different applications to manage and store the information, and the third party will use one or more different applications to publish documentation. It is not likely, however, that any of aforementioned groups will use the same application programs to perform their respective portions of the documentation process. It is also not likely that the software employed will be integrated. There are several drawbacks to the manual coordination approach, even when it is used on a relatively small scale. These drawbacks also make the manual coordination approach extremely difficult to manage even on a small scale.

One drawback of the manual coordination approach is that it is susceptible to document consistency problems. It is often the case that information is created and stored in one format, copied and converted to another format for content management, and copied and converted to yet another format for publication and/or delivery of the information. The result is that information now exists in three different formats and there are three different versions to maintain. Now, whenever part of the documentation is changed, each electronic copy of the documentation must be updated to reflect the change. Maintaining consistency of information in any different versions can be problematic, and depending on the frequency and nature of changes to the information, maintaining consistency is not always feasible.

Under the manual coordination approach of previous systems, in lieu of storing all of the documentation information in a single source, the information is stored in multiple electronic files in multiple electronic formats at any point in the documentation cycle. In many cases, several copies of the same information may be stored in separate incompatible electronic files. Document consistency problems are possible when information comes from multiple sources as opposed to coming from a single source. Multiple sources permit consistency problems to arise at any point in the documentation cycle especially when managing or publishing documentation. Consistency problems may also lead to document version control issues. When multiple copies of a document are not consistent with one anther, multiple copies turn into multiple versions of a document.

The second approach involves an all-in-one documentation system. This second approach also suffers from several drawbacks. One such drawback to the all-in-one approach is that such systems are proprietary, closed systems. A problem encountered with this is that information stored in such a system is not stored in a format that is based on industry standards. Another implication of the all-in-one approach is that there may be little to no interoperability between an all-in-one system and a third party application. This means that it may be quite difficult to import or merge work done in a third party application into a proprietary all-in-one system. Another drawback is that while an all-in-one approach may provide integration of the components in the all-in-one system, the components may not necessarily be the most preferred components to accomplish any one task, much less accomplish one of the stages of the documentation cycle. Thus, the drawback to an all-in-one system that performs some or all of the functions of the documentation lifecycle, is that the all-in-one system may not perform any one task especially well.

Another drawback of prior approaches using an all-in-one documentation system is that a cost associated with adopting and using a proprietary all-in-one system is multi-faceted and is many times expensive. Initially, the cost of license fees to purchase a proprietary system can be expensive. Next, before the system is placed in service, existing documents and other legacy information need to be converted and imported into the proprietary system. Next, it is likely that one can expect to incur training expenses so existing personnel can use the proprietary system. Even following training, one can expect to encounter a learning curve while existing personnel experience become familiar with the all-in-one system. Next, in the case of a proprietary all-in-one system, there is a cost associated with not being able to re-use existing components that may already be in place. Examples of existing components that are not used with a proprietary system may include XML editors and advanced graphics programs, data repository systems including hardware and software, and programs for used to accomplish publication activities proprietary all-in-one system. This expense can be considerable as it is not uncommon for a business to have existing web servers, database systems, authoring tools, and publication tools which can no longer be used with an all-in-one documentation system. As such, these closed documentation systems tend to be inflexible and do not scale well to adapt to changing needs. Due to the expense involved, the all-in-one approach has not been widely adopted or found particular favor.

Another drawback that is common to prior systems is that these systems do not utilize the content and structure of stored information. Generally, prior systems use a document-centric approach to handling information stored within a system. An implication of this is that, to the extent prior systems manage documents at all, documents are managed as simple objects. A consequence of the document-centric approach of managing simple document objects is that it is not possible to easily reuse information contained in a document, without creating a copy of the original document, and then making a derivative work, another version of the document. As such, the same information exists in a number of different documents and is not maintained or originated from a single source. A limitation of existing documentation systems due to the provision of inadequate document reuse is that existing systems do not provide the ability for the creation, management and publication of technical information from a single source.

In some cases, prior all-in-one systems have steered away from the document-centric approach and have opted to manage information in sub-document units. These prior systems are known in the art as “content,” “information,” or “document” management systems. These prior systems split up the information in a document and store it in sub-document units which are later combined to form a document.

Such prior all-in-one systems usually include or data repository storage mechanisms such as relational and object oriented databases. As previously mentioned, one of the drawbacks to an all-in-one approach is that information contained in prior systems is often stored in a proprietary format. As also previously mentioned, prior all-in-one systems tend to be inflexible. For example, in prior systems, once the data structure for the data repository has been established, subsequent modifications to the data structure cannot be easily made. In some cases, it is not possible to change the data structure at all. In prior systems where it is possible to change the data structure, making such a change may be quite costly. The expense is due to the fact that it is often necessary to rewrite major portions of the system and modify system components in order make changes to the data structure in prior all-in-one systems. One reason why modification to system components is often necessary can be attributed to the fact that prior all-in-one systems use native information handling mechanisms when retrieving or storing information from the system database. The native information handling mechanism in a given all-in-one system is specific to that one system.

Given the rapid pace of today's business, companies are frequently faced with new or changed business requirements which involve modifying existing content or adding new content types. Accommodating these requirements often affect the storage, searching, and distribution functions of documentation systems. Prior systems have typically been designed to handle the content and types of content existing when the system was designed. For example, if the original content source was a book, then the system would be configured to handle the content typically found in a book, such as text and pictures. Configuring such a system would involve creating a database structure to store text and picture content types, creating a user interface to access text and picture content types, creating search functions to locate text and picture content types, and creating reporting functions to publish text and picture content types.

A drawback to prior systems is that adding a new content type, such as video or audio content, has involved rewriting all, or most of the parts of the system. This would be the case in order for a prior system to be able to store and manage any content type that the system was not initially configured to handle. It is often the case that a single change to one part of a documentation system affects all or most of the other parts of the documentation system. Adding a new content type to a documentation system amounts to a data structure modification. For example, in order to add a new multimedia content type to an existing documentation system would initially involve manually modifying the structure of the system database. It should also be noted that it is likely that some modification of existing content would be necessary to permit legacy data to make use of the new content type. Additionally, the system graphical user interface, reports, documents and forms, as well as the underlying system interfaces, would require modification in order to make the new content type visible and/or accessible to anyone using the system. Thus, changing data structure in a documentation system involves changing user and system interfaces throughout the system.

As previously mentioned, prior systems are often closed, proprietary systems. Making changes to the data structure of a prior system tends to be both difficult and expensive. As also previously mentioned, a single change typically affects many lines of application code throughout the entire system. In prior systems, application code modifications have been made manually and have required the time and expertise of a programmer or group of programmers. It should also be noted that it often the case that the vendor/author of the proprietary system is the only one permitted to make any changes to the system. Accordingly, the timeframe and expense involved with making modifications to a proprietary system have been largely dependent on the availability, responsiveness and modification surcharge rates a single vendor.

Accordingly, it is desirable to provide a system that makes use of existing applications while avoiding the consistency problems of previous approaches. It is also desirable to provide a system that provides integration of existing applications while not incurring the document consistency problems of prior approaches. It is also desirable to provide a system that provides the ability to re-use information contained in the documentation stored in the system. It is also desirable to provide a system that permits the creation, management and publication of information from a single source. Accordingly, it is desirable to provide a system in which adjustments can be made to data structure of a data repository or to the way that information is handled without having to manually rewrite major portions of the system. Additionally, it is desirable to provide a system that is adaptable to satisfy changing requirements in a timely and cost-effective fashion.

### SUMMARY OF THE INVENTION

The foregoing needs are met, to a great extent, by the present invention, wherein in one aspect an apparatus is provided that in some embodiments the documentation system provides a framework to manage all phases of the information/document creation, management and publishing process using existing applications. Additionally, another embodiment provides the ability to manage and perform the tasks associated with the phases of the documentation lifecycle via a web browser.

In accordance with one embodiment of the present invention a component independent documentation system is provided that includes a workflow component, a data repository component, a media manager component and an application server component. The application server component is linked and configured to interact with the data repository component, the media manager component and the workflow component.

In accordance with another embodiment of the present invention, a component independent documentation system that includes a data repository component having a data repository adapter linked to a data repository interface, a media manager component having a program adapter linked to an media manager interface, a workflow component having a workflow engine adapter linked to a workflow interface and an application server component. The application server component is linked and configured to interact with the data repository component, the media manager component and the workflow component.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of the architecture of a documentation system according to a preferred embodiment of the invention.

FIG. 2 is an illustration of an alternate architecture of a documentation system according to an another preferred embodiment of the invention.

FIG. 3 is an illustration of an alternate architecture of a documentation system according to another preferred embodiment of the invention.

FIG. 4 is an illustration of an alternate architecture of a documentation system according to another preferred embodiment of the invention.

FIG. 5 is an illustration of the architecture for a system for composition and decomposition of information objects according to a preferred embodiment of the invention.

FIG. 6 is an illustration of an alternate architecture for a system for composition and decomposition of information objects according to another preferred embodiment of the invention.

FIG. 7 is an illustration of an architecture of a documentation system including a system for composition and decomposition of information objects according to another preferred embodiment of the invention.

FIG. 8 is a block diagram illustrating the steps that may be followed in accordance with a preferred embodiment of the method of the invention.

FIG. 9 is a block diagram illustrating the steps that may be followed in accordance with another preferred embodiment of the method of the invention.

FIG. 10 is an illustration of an XML code fragment from an XSL file in accordance with a preferred embodiment of the invention.

FIG. 11 is alternate illustration of an XML code fragment from an XSL file in accordance with a preferred embodiment of the invention.

FIG. 12 is an illustration of the architecture of a system for content structure adaptation according to a preferred embodiment of the invention.

FIG. 13 is an illustration of an alternate architecture of a system for content structure adaptation according to a preferred embodiment of the invention.

FIG. 14 is an illustration of a metadata grammar code fragment in accordance with a preferred embodiment of the invention.

FIG. 15 is an illustration of a structure data grammar code fragment in accordance with a preferred embodiment of the invention.

FIG. 16 is an illustration of a metadata descriptor code fragment in accordance with a preferred embodiment of the invention.

FIG. 17 is an illustration of a structure data descriptor code fragment in accordance with a preferred embodiment of the invention.

FIG. 18 is an illustration of a graphical user interface in accordance with a preferred embodiment of the invention.

FIG. 19 is an illustration of a code generator code fragment in accordance with a preferred embodiment of the invention.

FIGS. 20A and 20B are an illustration of a code library code fragment in accordance with a preferred embodiment of the invention.

FIG. 21 is an illustration of a generated code fragment in accordance with a preferred embodiment of the invention.

### DETAILED DESCRIPTION

The invention will now be described with reference to the drawing figures, in which like reference numerals refer to like parts throughout. An embodiment in accordance with the present invention provides a framework to manage all phases of the information/document creation, management and publishing process using existing applications. Additionally, an embodiment in accordance with the present invention provides a framework that permits integration of new or existing components such as databases and editors into an integrated documentation system. Another embodiment in accordance with the present invention provides a system and method for the composition and decomposition of information objects that is independent of the underlying data repository.

One embodiment of the present invention provides an integrated documentation system with a viewer component, an editor, a workflow controller, and a media manager. The viewer component enables documents to be viewed on the Internet using a web browser such as Microsoft Internet Explorer, Mozilla or Konqueror. The web browser further includes XML compatibility and support for application plug-ins or helper applications. The editor program is a markup language editor such as a Standard Generalized Markup Language (SGML) or an Extensible Markup Language (XML) editor which is used by authors to create documents based on an integrated customer-specified Document Type Definition (DTD). The workflow controller controls and coordinates review, approval and publication of documentation by authors, editors and illustrators. The media manager integrates new documents into the documentation base and changes the metadata of individual documents. The media manager also supports the upload and download of large amounts of documents.

A documentation system in accordance with the present invention features an abstraction between the system interface and an application specific adapter. Additionally, an embodiment in accordance with the present invention provides the ability to create, manage and publish information from a single source. Also, in accordance with the present invention, in one embodiment, access is provided to all phases of the documentation lifecycle via a web browser.

A system for the composition and decomposition of information objects in accordance with the present invention provides an abstraction layer between a data repository and an composition and decomposition module which permits changes to be made to the data repository without affecting the composition and decomposition module. Additionally, another layer of abstraction provided by the system permits changes to be made to the operation of the composition and decomposition module without rewriting or having to modify the module.

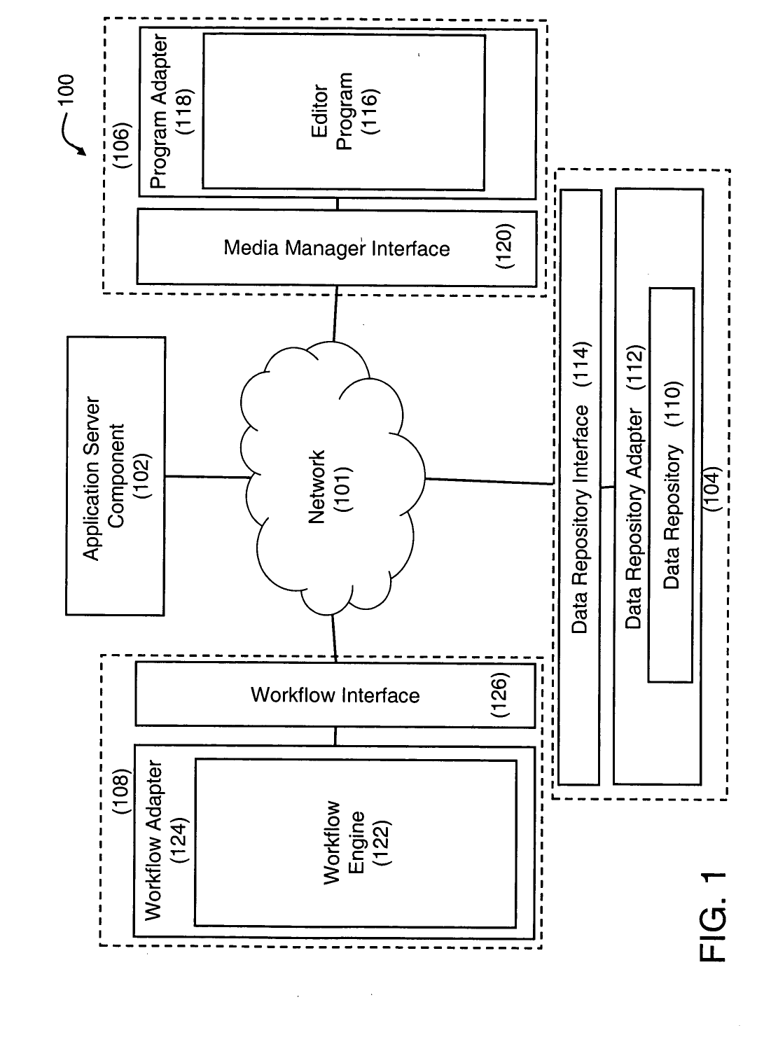

An embodiment of the present inventive system and method is illustrated in FIG. 1. FIG. 1 includes a documentation system 100 with a network 101 linked to an application server component 102, a data repository component 104, a media manager component 106, and a workflow component 108. While FIG. 1 shows components connected using a network 101, it should be understood that the documentation system components may reside on the same computer. A computer should be broadly construed to mean any device capable of processing or accessing information such as a pc, server, mini-computer, workstation, personal digital assistant (PDA) or terminal.

The data repository component 104 includes one or more data repositories 110, a data repository adapter 112 and a data repository interface 114. The data repository 110 is linked to a data repository adapter 112 which is linked to the data repository interface 114. Communications to and from the data repository component 104 occur via the data repository interface 114.

The data repository adapter 112 links the data repository 110 to the data repository interface 114. The data repository adapter 112 supplies implementation of the data repository interface 114 and implements the functionalities required by deploying appropriate mapping onto the potential of the actual data repository 110. In addition to the actual mapping of the functionality, the documents and metadata into and out of the documentation system are translated into the corresponding data repository 110 representations. The repository adapter 112 enables any functionalities not present in the data repository 110 to be supplied by implementing them as appropriate, or enables persistence maintenance to be distributed among a number of systems which then take on the “external” form of a single system.

To optimize adaptation to individual tasks, the adapter definition involves registering specific handlers that support data transformation for both read and write operations. An example of a handler may utilize eXtensible Style Language (XSL). The adapter can be used by instancing an Enterprise JavaBean (EJB) or native use of a Java library within another module of another application. Using this method, access to the repository can be integrated almost invisibly into existing applications, which then appear as part of the overall documentation creation process.

The media manager component 106 includes one or more programs 116, a program adapter 118, and a media manager interface 120. The media manager component 106 includes one or more programs 116 such as an SGML/XML editor program, a word processor, or a graphical illustration program. The program adapter 118 connects one or more programs 116 to the media manager interface 120. The program adapter 118 serves as a link between the media manager interface 120 and one or more application programs 116. Communications to and from the media manager component 106 are occur via the media manager interface 120. The media manager component 106 is linked to the application server component 102 via the media manager interface 120.

The media manager component 106 is used when data is written into or read from the data repository component 104. Additionally, the media manager component 106 is used when a functionality requiring user input is needed. The media manager component 106 supplies the user interface with the documentation system and provides services as a standalone application and supplies dedicated functions when they are requested by other system modules. The provision of this function is desirable should a non-Java enabled application need to be integrated using a Java-component object model (COM) bridge. The media manager component 106 creates the correct instance of the data repository adapter 112 and supplying it with appropriate values, such as the user id and IP address. Additionally the media manager component 106 supplies the interface to the workflow component 108 for providing workflow information.

The workflow component 108 includes one or more workflow engines 122, a workflow engine adapter 124 and a workflow interface 126. The workflow component 108 controls the document processing sequence, supplying a controlled environment for document changes, review, approval and publication. Additionally, the workflow component 108 serves to coordinate processing of the documentation as a whole by authors, editors and illustrators thus preventing documents undergoing processing from being accessed by other authors. The workflow engine adapter 124 connects one or more workflow engines 122 to the workflow interface 126. The workflow component 108 is linked to the application server component 102 via the workflow interface 126.

The network 101 may be a distributed network which may be implemented as an intranet, a local area network (LAN), or a wide area network (WAN) such as the Internet. Additionally, the network 101 may also be the medium used to provide communications links between network connected devices and may include switches, routers, hubs, wired connections, wireless communication links, or fiber optic cables. The application server component 102 may include one or more computers which may store one or more components of the documentation system. Additionally, the application server component 102 may also provide a web based graphical user interface to access one or more of the documentation system components. The application server component 102 may also include various web applications including a document viewers. According to one embodiment of the invention, the application server component 102 is implemented using the current JBoss-2.4.3_Tomcat-3.2.3 combined with SUN Java Development Kit 1.3.1.

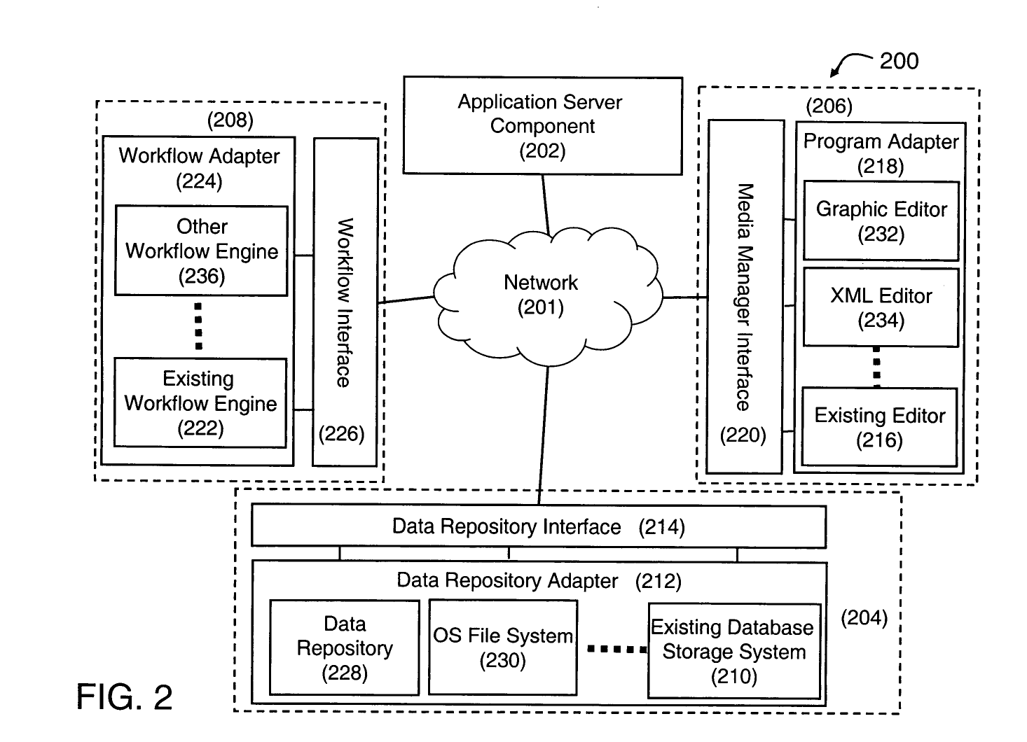

Another embodiment of the present inventive system and method is illustrated in FIG. 2. FIG. 2 includes a documentation system 200 with a network 201 linked to an application server component 202, a data repository component 204, a media manager component 206, and a workflow component 208. The data repository component 204 includes one or more data repositories such as an existing database storage system 210, a data repository 228 and an operating system (OS) file system 230. The data repository component 204 further includes a data repository adapter 212 and a data repository interface 214. The media manager component 206 includes one or more programs such as an existing editor application 216, a graphic editor 232, and an XML editor 234. The media manager component 206 further includes a program adapter 218 and a media manager interface 220. The workflow component 208 includes one or more workflow engines such as an existing workflow system 222 or a workflow system from a different vendor 236, as well as a workflow adapter 224 and a workflow interface 226.

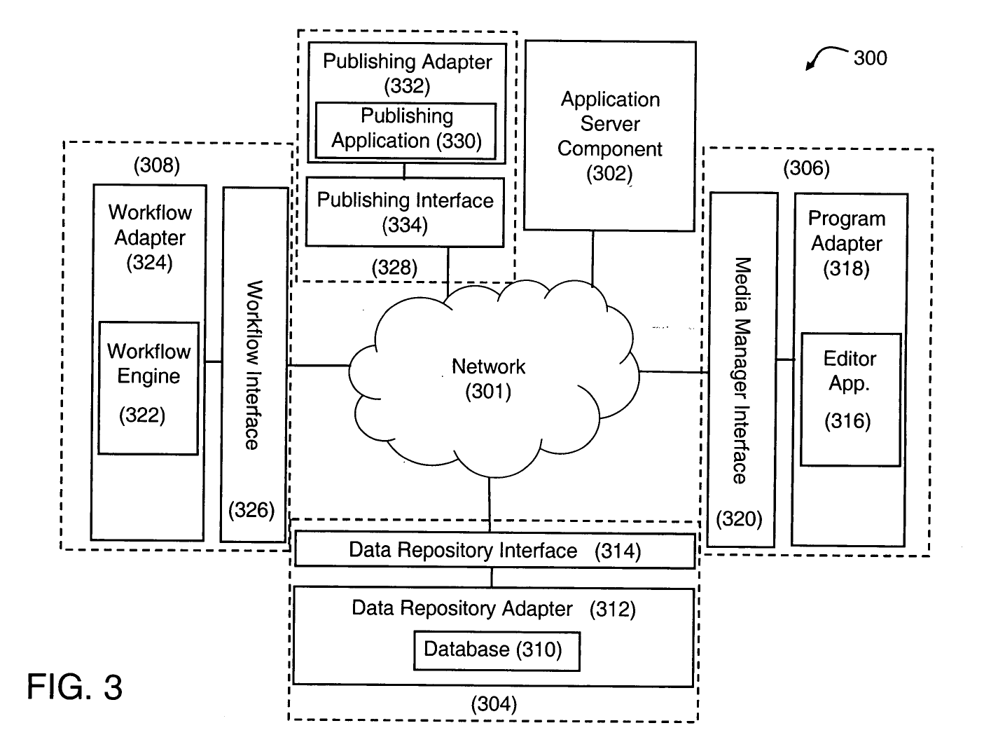

Another embodiment of the present inventive system and method is illustrated in FIG. 3. FIG. 3 includes a documentation system 300 with a network 301 linked to an application server component 302, a data repository component 304, a media manager component 306, a workflow component 308 and a publishing component 328. The data repository component 304 includes one or more databases 310, a data repository adapter 312 and a data repository interface 314. The media manager component 306 includes one or more programs 316, a program adapter 318 and a media manager interface 320. The workflow component 308 includes one or more workflow engines 322, a workflow adapter 324 and a workflow interface 326. The publishing component 328 includes one or more publishing applications 330, a publishing adapter 332 and a publishing interface 334.

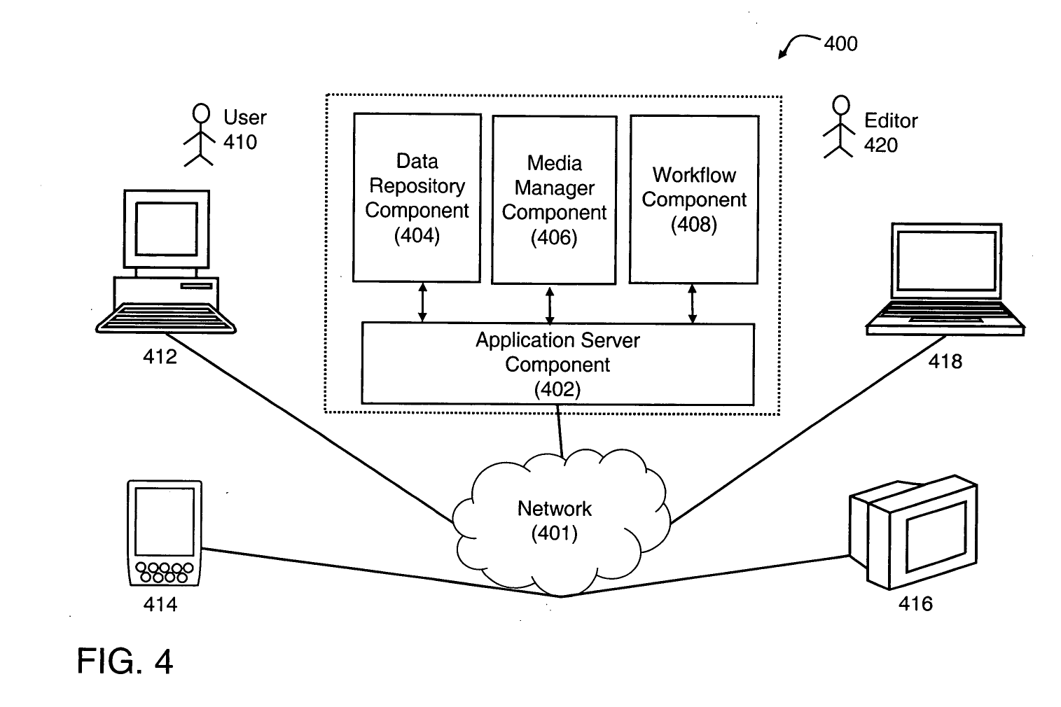

Another embodiment of the present inventive system and method is illustrated in FIG. 4. FIG. 4 includes a documentation system 400 with a network 401 linked to an application server 402. The application server 402 includes a data repository component 404, a media manager component 406, and a workflow component 408. It should be understood that the application server 402 may include one or more machines which may store one or more components of the documentation system. A end user 410 may access the application server 402 to view documentation via a device that is linked to the network 401 where the device is running a viewer application such as a web browser. Examples of network connected devices include a computer 412, personal digital assistant (PDA) 414, kiosk 416 or portable computer 418. An editor user 420 may access the application server 402 to edit documentation a network connected device, such as those described above. The editor user 420 may also access the application server 402 to edit documentation using a third party application such as an XML editor.

By way of example, the editor user 420 uses an editing program on portable computer 418 to create a new document. Once the editor user 420 has created the document, the editor user 420 uses portable computer 418 to connect to application server component 402 via network 401. Once linked to the application server component 402, the editor user 420 uses the media manager component 406 to add and import the document into the system. The media manager component 406 generates document data and document metadata by separating the content of the document from the formatting and presentation of the document. The media manager component 406 stores the document data and document metadata by using the data repository component 404.

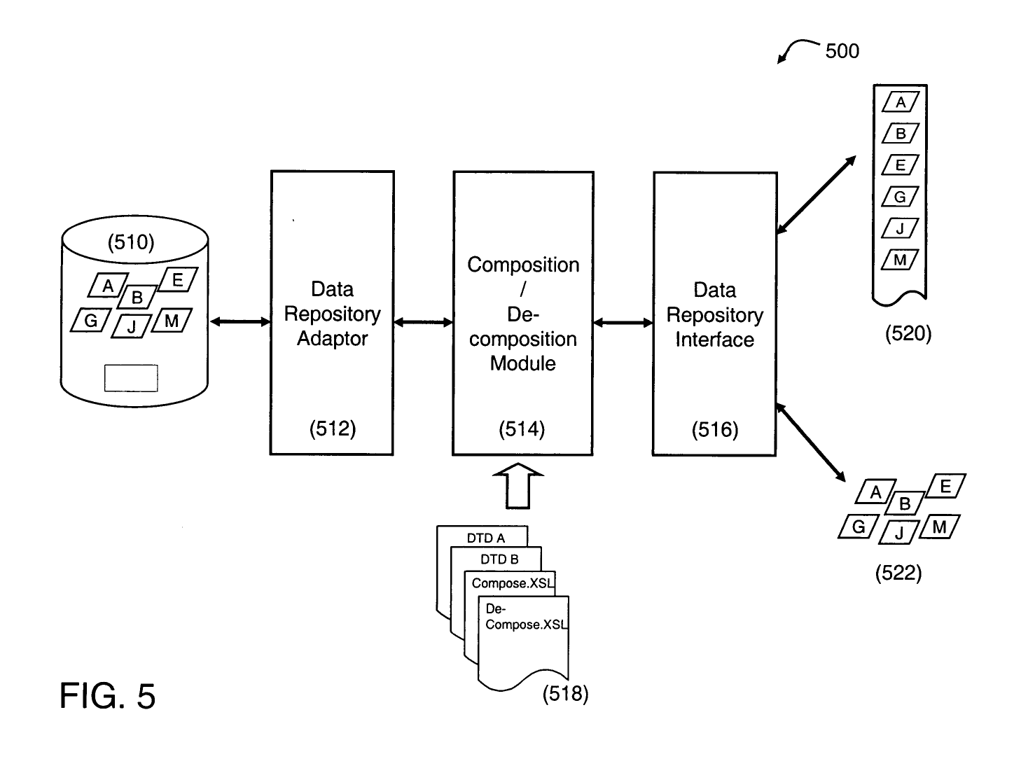

An embodiment of the present inventive system and method is illustrated in FIG. 5. FIG. 5 includes a system for composition and decomposition of information objects 500, with one or more data repositories 510, a data repository adapter 512, a composition/decomposition module 514 and a data repository interface 516. Also included is a content logic specification 518 which instructs the composition/decomposition module 514 how to compose information objects into one or more large information objects 520 or decompose information objects into small information objects 522. The data repository 510 is linked to a data repository adapter 512 which is linked to the composition/decomposition module 514. The composition/decomposition module 514 is linked to the data repository interface 516. Communications to and from the data repository 510 occur through the data repository adapter 512. Communications to or from the composition/decomposition module 514 occur through the data repository adapter 512 or the data repository interface 516. Communications to the system for composition and decomposition of information objects 500 occur through the data repository interface 516.

The composition/decomposition module 514 receives commands from the data repository interface 516 and based on the client logic specification 518, it either composes or decomposes information objects. When the composition/decomposition module 514 composes information objects, it composes one or more large information objects 522 by combining smaller information objects. When the composition/decomposition module 514 decomposes information objects, it splits one or more large information objects 522 into smaller information objects 520. The composition/decomposition module 514 delivers the resulting information objects 520 or 522 to the data repository interface 516. Additionally, the composition/decomposition module 514 can also send the resulting information objects 520 or 522 to the data repository adapter 512. According to one embodiment of the present invention, the composition/decomposition module 514 is implemented using extensible stylesheets (XSL) or extensible stylesheet language transformations (XSLT).

The content logic specification 518 provides the composition/decomposition module 514 with instructions and parameters to compose and decompose information objects. The content logic specification 518 includes configuration files such a XML and SGML DTD's, XML schemas, metadata and structure data specifications as well as XSL stylesheets. The content logic specification 518 is derived from an analysis of information content, purpose specific DTD's, metadata, structure definition files, as well as identifying textual and binary information objects.

The data repository adapter 512 provides a layer of abstraction to the system that permits changes to be made to the underlying data repository 510 without any modification to the other components of the system for composition and decomposition of information objects 500. Because of the layer of abstraction provided by the data repository adapter 512 that is specific to the underlying data repository 510, it is possible to entirely replace the underlying data repository with another type or brand of repository without any modification to the other components of the system. Additionally, use of the content logic specification 518 permits changes to be made to the operation of the composition/decomposition module 514 without any modification to the composition/decomposition module 514 itself. An additional benefit of the layer of abstraction provided by the data repository specific adapter 512 and the content logic specification 518 is that it is possible to work around limitations in the underlying data repository 510 without having to rewrite any component of the system for composition and decomposition of information objects 500.

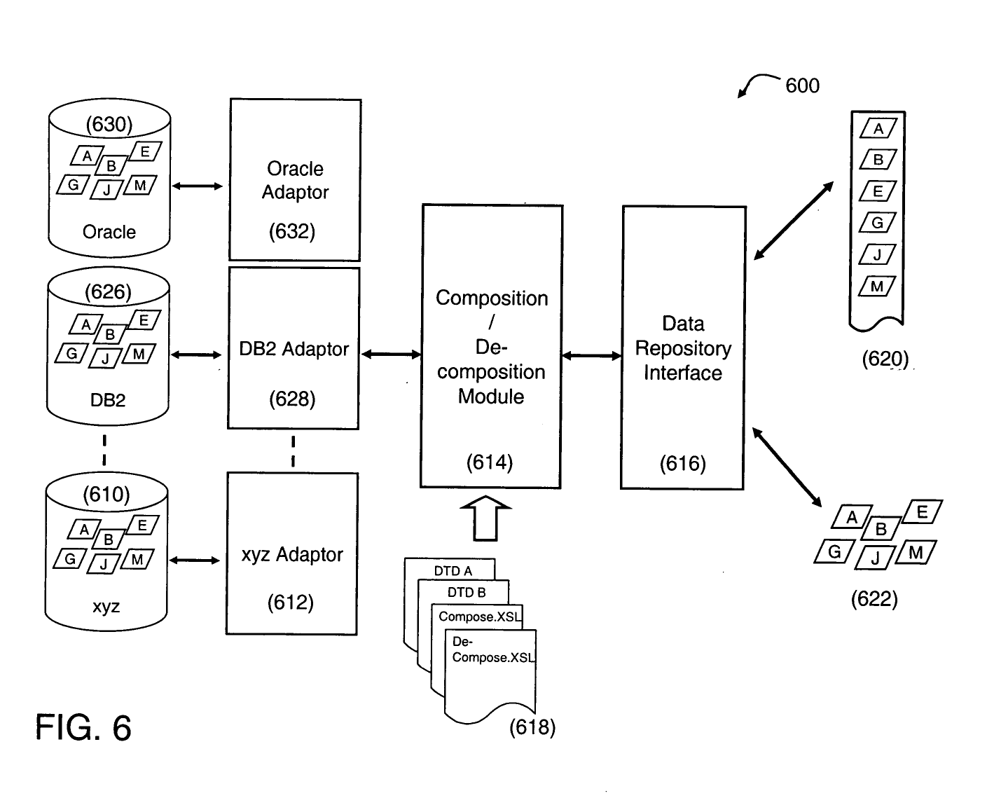

Another embodiment of the present inventive system and method is illustrated in FIG. 6. FIG. 6 includes a system for composition and decomposition of information objects 600, with one or more data repositories 610, one or more data repository adapters 612, a composition/decomposition module 614, and a data repository interface 616. The system for composition and decomposition of information objects 600 also includes a content logic specification 618 which instructs the composition/decomposition module 614 how to compose information objects into one or more large information objects 620 or decompose information objects into small information objects 622. Data repository 610 is an xyz brand data repository, which is linked to data repository adapter 612 which is specific to the xyz brand data repository 610. Also shown are a DB2 brand data repository 628 linked to a DB2 adapter 628, and an Oracle data repository 630 linked to an Oracle adapter 632.

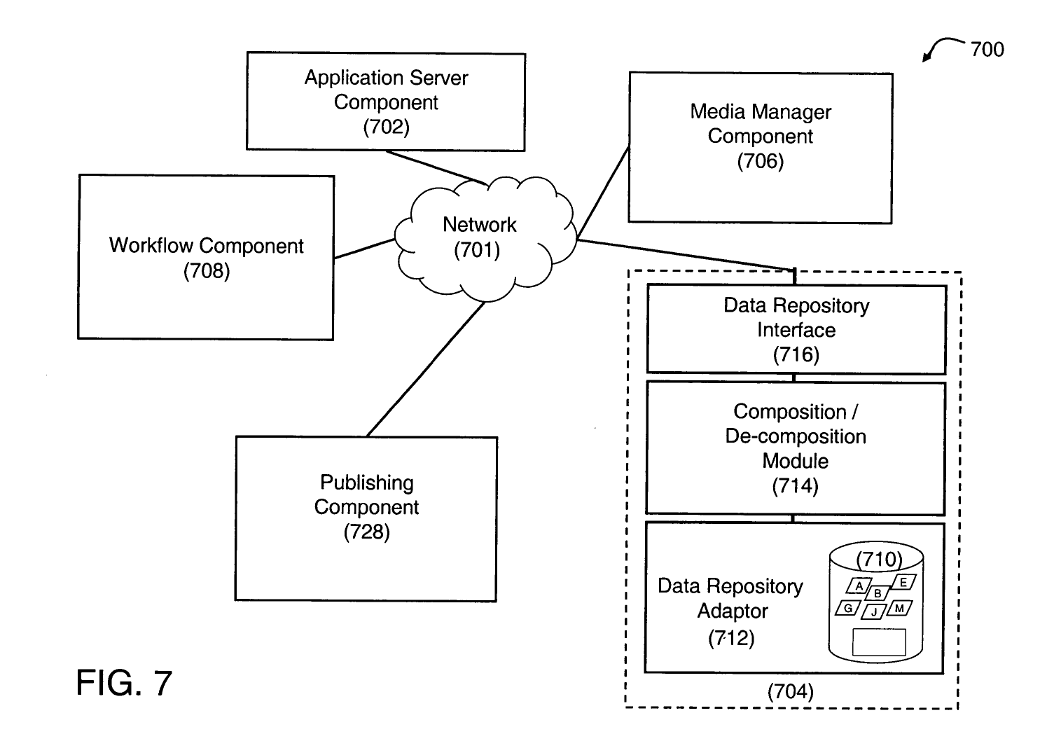

Another embodiment of the present inventive system and method is illustrated in FIG. 7. FIG. 7 includes a documentation system 700 with a network 701 linked to an application server component 702, a data repository component 704, a media manager component 706, a workflow component 708 and a publishing component 728. The data repository component 704 includes one or more data repositories 710, a data repository adapter 712, a composition/decomposition module 714 and a data repository interface 716. Communications to and from the data repository component 704 occur via the data repository interface 716.

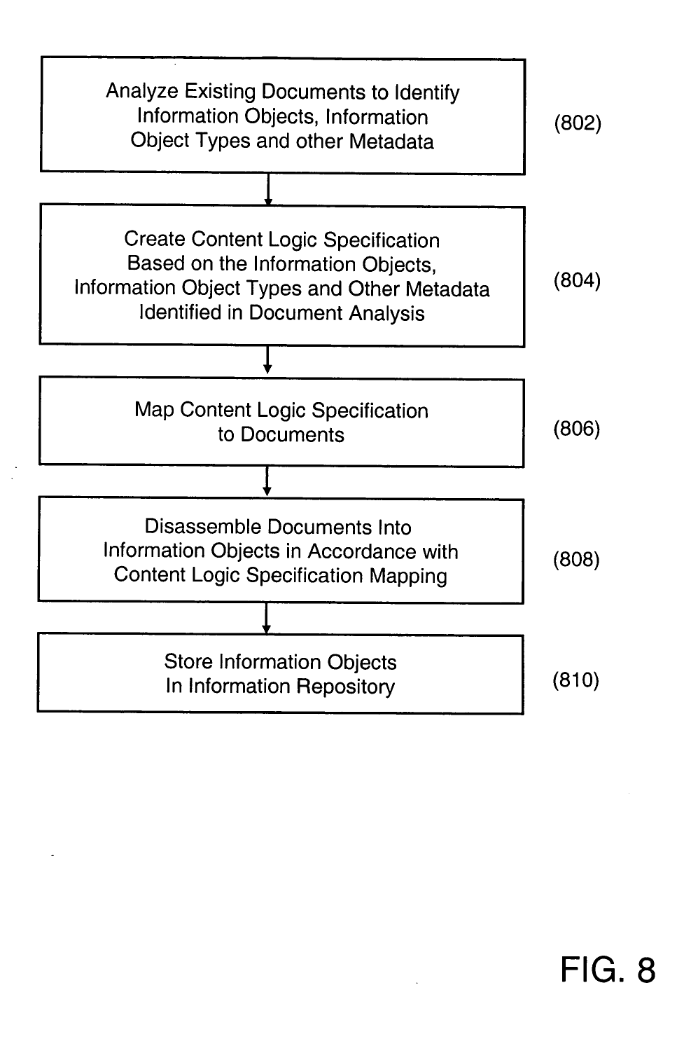

Another embodiment of the present inventive system and method is illustrated in FIG. 8. FIG. 8 is a block diagram illustrating the steps that may be followed in accordance with a preferred embodiment of the method of composing information objects. In step 802, existing documents are analyzed to identify information objects, information object types and other Metadata present in the documents. In step 804, a content logic specification is created based on the information objects, information object types and other metadata identified in the document analysis of step 802. In step 806, the content logic specification is mapped to the existing documents. In step 808, the existing documents are disassembled into information objects in accordance with the mapping of the content logic specification performed in step 806. In step 810, the information objects resulting from the disassembly of step 808 are stored in a information repository.

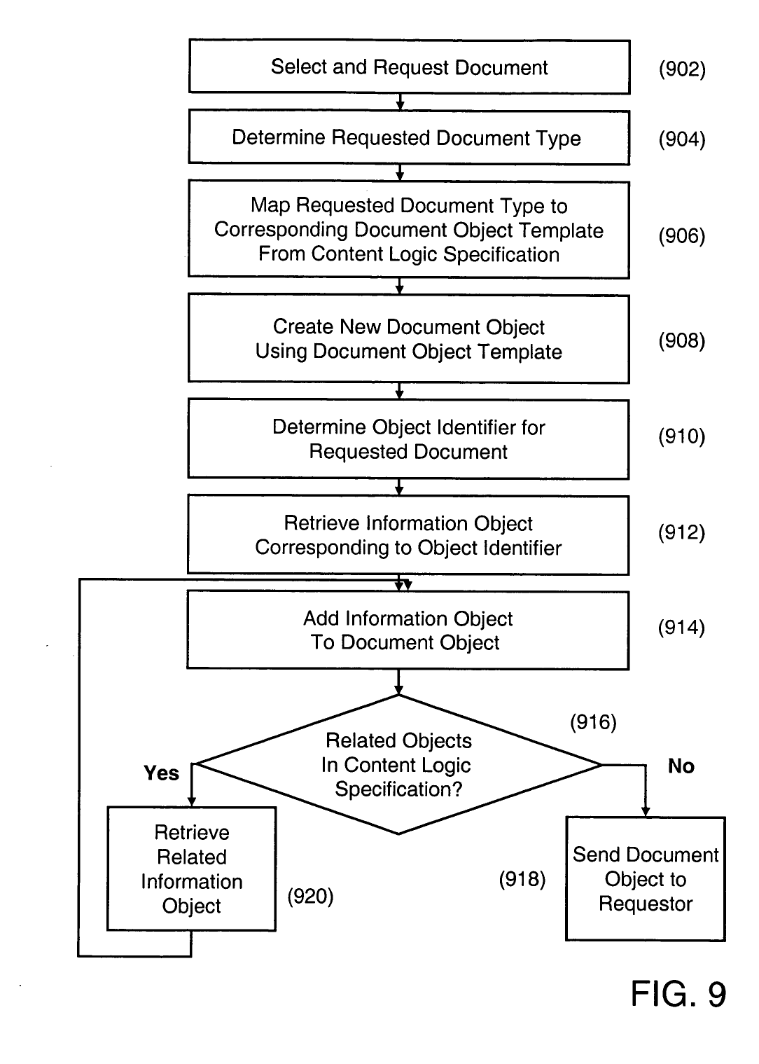

Another embodiment of the present inventive system and method is illustrated in FIG. 9. FIG. 9 is a block diagram illustrating the steps that may be followed in accordance with a preferred embodiment of the method of decomposing information objects. In step 902, a document is selected and requested. In step 904, the document type of the requested document is determined. In step 906, the requested document type is mapped to a stylesheet or corresponding document object template that is specified for the document type by content logic specification. In step 908, a new document object is created/instantiated using the stylesheet or document object template definition mapped in step 906. In step 910, the object identifier for the document requested in step 902 is determined. In step 912, the information object identified by the object identifier is retrieved. In step 914, the information object that has just been retrieved is added to the to the document object instantiated/created in step 908. In step 916, a check is made to determine if the content logic specification indicates that related objects exist. In step 918, if the content logic specification does not indicate that there are any related objects, or that all of the related information objects have been retrieved and added to the document object, the document object is complete and is sent to the document requestor. In step 920, if the content logic specification indicates that there is/area related object(s), those object(s) are retrieved and added to the document in step 914.

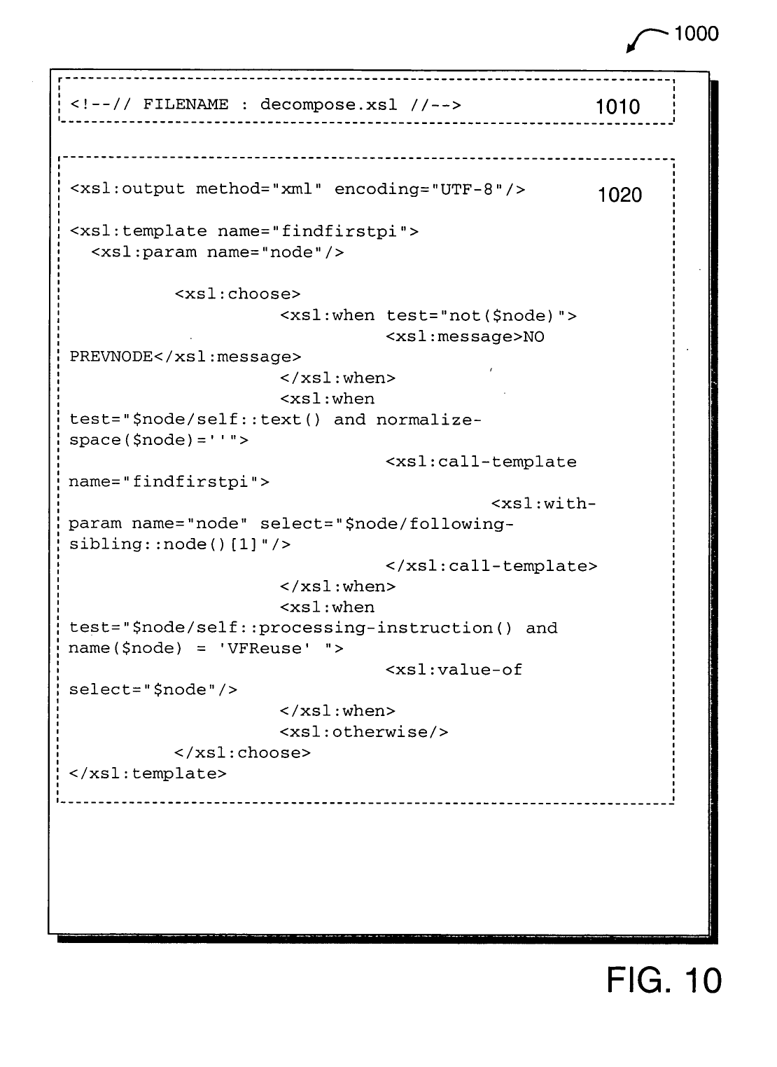

Another embodiment of the present inventive system and method is illustrated in FIG. 10. FIG. 10 is an illustration of an XML code fragment from an XSL file in accordance with a preferred embodiment of the invention. XML code fragment 1000 includes a comment 1010 and an XSL template definition 1020. Comment 1010 indicates that this code fragment is from the portion of the content logic specification 518 that instructs the decomposition module 514 how disassemble large information objects into smaller information objects.

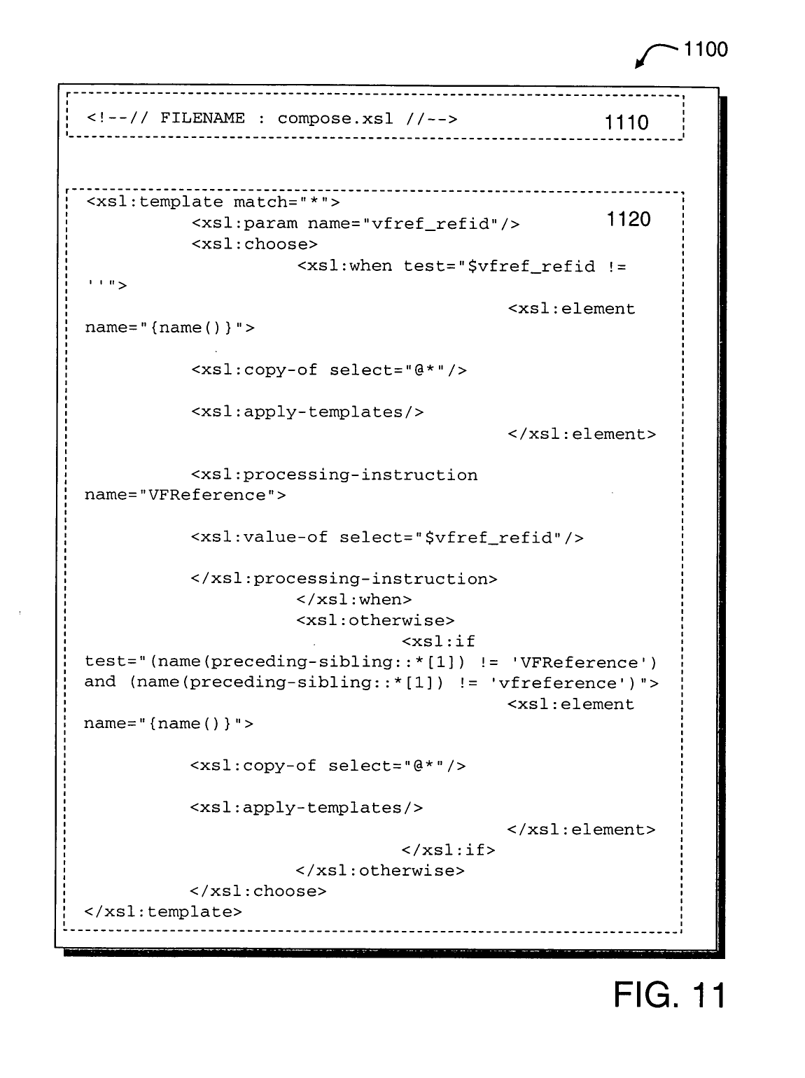

Another embodiment of the present inventive system and method is illustrated in FIG. 11. FIG. 11 is alternate illustration of an XML code fragment from an XSL file in accordance with a preferred embodiment of the invention. XML code fragment 1100 includes a comment 1110 and an XSL template definition 1120. Comment 1110 indicates that this code fragment is from the portion of the content logic specification 518 that instructs the composition module 514 how to assemble information objects into one or more large information objects.

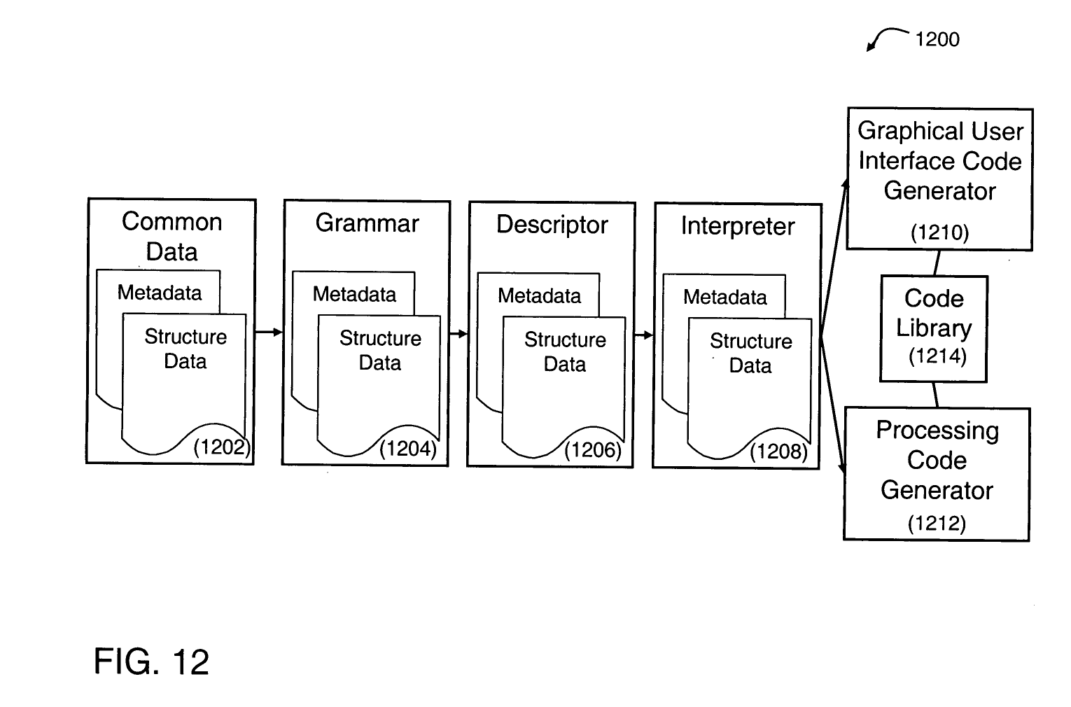

Another embodiment of the present inventive system and method is illustrated in FIG. 12. FIG. 12 is an illustration of the architecture of a system for content structure adaptation according to a preferred embodiment of the invention. FIG. 12 includes a system for content structure adaptation 1200 with common data 1202 linked to a grammar specification 1204 which is linked to a descriptor 1206 which is linked to an interpreter 1208. The interpreter 1208 is linked to a graphical user interface code generator 1210 and a processing code generator 1212. The graphical user interface code generator 1210 and processing code generator 1212 are linked to a code library 1214.

The content structure adaptation system 1200 produces the application source code for a documentation system, such as any one of the systems illustrated in FIGS. 1-4 and 7. More particularly, the structure adaptation system 1200 is used to create or modify the components of a documentation system. Examples of documentation system components are illustrated in FIGS. 1-7. An advantage of using the content structure adaptation system 1200 is that making changes to the data structure of a documentation system is accomplished by editing a configuration file, as opposed to manually reconfiguring or rewriting source code. Another advantage provided by the content structure adaptation system 1200 is that the changes made by editing the configuration file are applied throughout all of the applicable system components. For example, to add a new type of content to the system of the present invention, one or more definitions and descriptions for the new content type would be added to one or more configuration files. Based on the description of the new data type in the configuration file, and the abstraction level of the content adaptation system 1200, when the content structure adaptation system 1200 is subsequently run, the new data type is added throughout the system, from data repository to the graphical user interface.

The common data 1202 includes content, metadata, structure data derived from analyzing existing documents. The grammar specification 1204 defines all the primitives necessary to describe the structure and relationship of managed content types as well as the metadata used to describe, classify, and categorize the content. The grammar specification 1204 also includes metadata element names, types and values depending on the content type. According to one embodiment in accordance with the present invention, the grammar specification 1204 is expressed in the form of a DTD or an XML schema.

The descriptor 1206 is the result of applying the grammar specification 1204 to the common data 1202. The descriptor 1206 provides descriptions, definitions and configuration files such a XML and SGML DTD's, XML schemas, metadata specifications and structure data specifications. The interpreter 1208 receives an XML instance of the descriptor 1206 which defines the system requirements of the system. The interpreter sends the information defined in the XML instance to the graphical user interface code generator 1210 and the processing code generator 1212.

The graphical user interface code generator 1210 generates the application code for the system that is needed to support the requirements defined in the descriptor 1206. The graphical user interface code generator 1210 accomplishes this by semantic mappings between elements defined by the grammar specification 1204 and corresponding application code in the code library 1214. According to one embodiment in accordance with the present invention, the graphical user interface code generator 1210 is implemented using XSL and the code library 1214 is implemented as a stylesheet. For example, based on an element such as a <mdsimple id=“oem” type=“string” selectable=“yes”> defined in the descriptor 1206, the graphical user interface code generator 1210 knows to create all of the specific application code (C++, Java, HTML, etc.) that is required to produce a graphical user interface object with a label of “oem” that contains a selectable list of strings. If, for example the value of the attribute “selectable” been “no”, the graphical user interface code generator 1210 would have created a text box in the graphical user interface with a text box that the user could enter a string into. In HTML (for the selectable=“no” scenario), one example of the application code generated by the graphical user interface code generator 1210 would look like this:

<p>oem</p>
<br>
<input name=“oem” type=“text” >

The processing code generator 1212 generates the application code for the system that is needed to support the requirements defined in the descriptor 1206. The processing code generator 1212 accomplishes this by semantic mappings between elements defined by the grammar specification 1204 and corresponding application code in the code library 1214. According to one embodiment in accordance with the present invention, the processing code generator 1212 is implemented using XSL and the code library 1214 is implemented as a stylesheet. For example, based on an element such as a <mdsimple id=“oem” type=“string” selectable=“yes”> defined in the descriptor 1206, the processing code generator 1212 knows to create all the specific application code (C++, Java, HTML, etc.) that is required to process the oem meta-data object. One example is the creation of some class to store all the “oem” values. This includes both possible values (assuming it is selectable=“yes”) as well as all specific oem instances. Therefore, in this example, the processing code generator would produce SQL code to create the oem record such as:
INSERT INTO mdtable (md.name) VALUES (‘oem’);
commit;

It should be understood that while common data 1202, the grammar specification 1204, the descriptor 1206 and the interpreter 1208 are depicted in separate blocks, that multiple instances of these items may be present in an embodiment in accordance with the system and method of the present invention. Additionally, it will readily be understood by one skilled in the art, that while code library 1214 is illustrated as a single block, an embodiment of the present invention may include a plurality of code libraries.

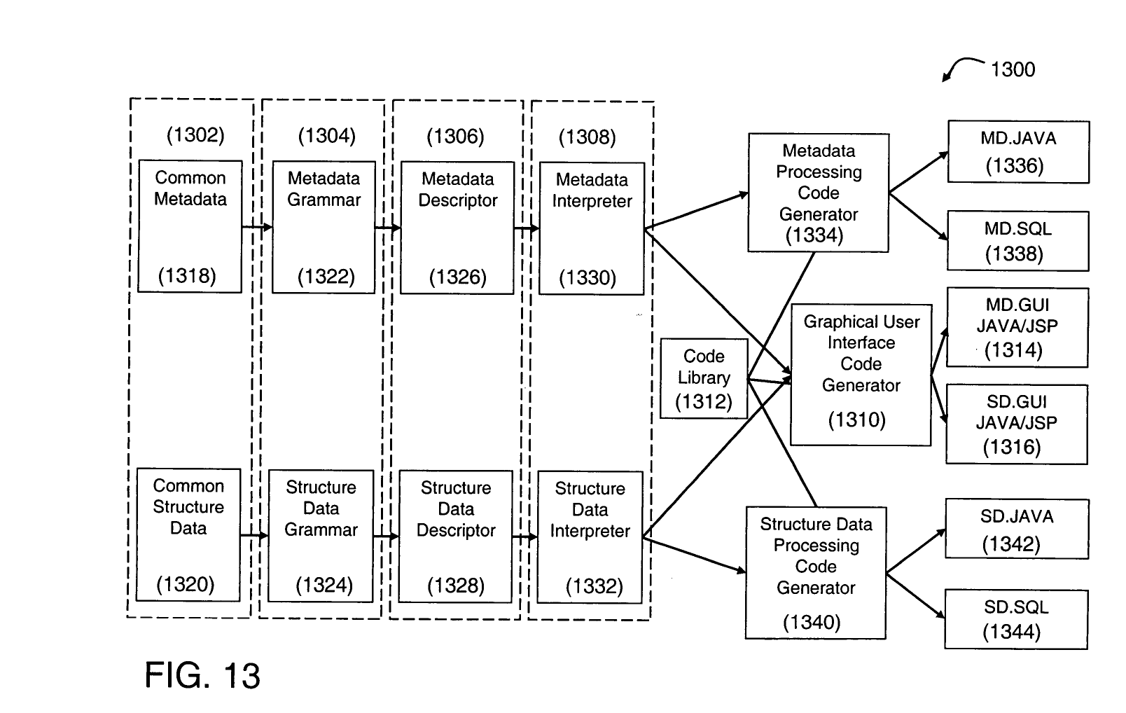

Another embodiment of the present inventive system and method is illustrated in FIG. 13. FIG. 13 is an illustration of an alternate architecture of a system for content structure adaptation according to a preferred embodiment of the invention. FIG. 13 includes a system for content structure adaptation 1300 with a common data module 1302 linked to a grammar specification module 1304 which is linked to a descriptor module 1306 which is linked to an interpreter module 1308. The interpreter module 1308 is linked to a graphical user interface code generator 1310. The graphical user interface code generator 1310 is linked to a code library 1312. The graphical user interface code generator 1310 produces metadata graphical user interface code 1314 and structure data code 1316. In one embodiment in accordance with the present invention, the metadata graphical user interface code 1314 graphical includes java and java server page code and the structure data graphical user interface code 1316 includes java and java server page code.

The common data module 1302 further includes common metadata 1318 and common structure data 1320. The grammar specification module 1304 further includes metadata grammar 1322 and structure data grammar 1324. The descriptor module 1306 further includes a metadata descriptor 1326 and structure data descriptor 1328. The interpreter module 1308 further includes metadata interpreter 1330 and structure data interpreter 1332.

The common metadata 1318 is linked to metadata grammar 1322 which is linked to a metadata descriptor 1326. The metadata descriptor 1326 is linked to a metadata interpreter 1330 which is linked to a metadata processing code generator 1334. The metadata processing code generator 1334 is also linked to a code library 1312. The metadata processing code generator 1334 produces metadata processing code 1336 and metadata data repository processing code 1338. In one embodiment in accordance with the present invention, the metadata processing code 1336 includes java code and the metadata data repository processing code 1338 includes structured query language (SQL) code.

The common structure data 1320 is linked to structure data grammar 1324 which is linked a structure data descriptor 1328. The structure data descriptor 1328 is linked to a structure data interpreter 1332 which is linked to a structure data processing code generator 1340. The structure data processing code generator 1340 is also linked to a code library 1312. The structure data processing code generator 1340 produces structure data processing code 1342 and structure data repository processing code 1344. In one embodiment in accordance with the present invention, the structure data processing code 1342 includes java code and the structure data repository processing code 1344 includes structured query language (SQL) code.

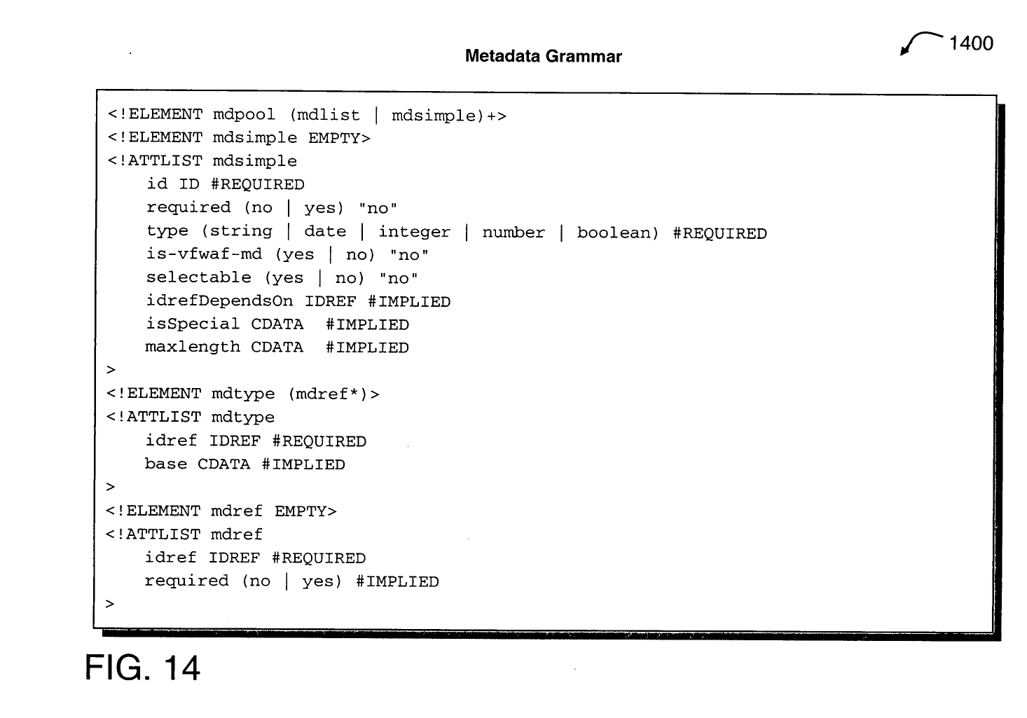

Another embodiment of the present inventive system and method is illustrated in FIG. 14. FIG. 14 is an illustration of a metadata grammar code fragment in accordance with a preferred embodiment of the invention. Metadata grammar code fragment 1400 includes element declarations and element attribute declarations. According to an embodiment of the present invention the metadata grammar can be a DTD or an XML schema.

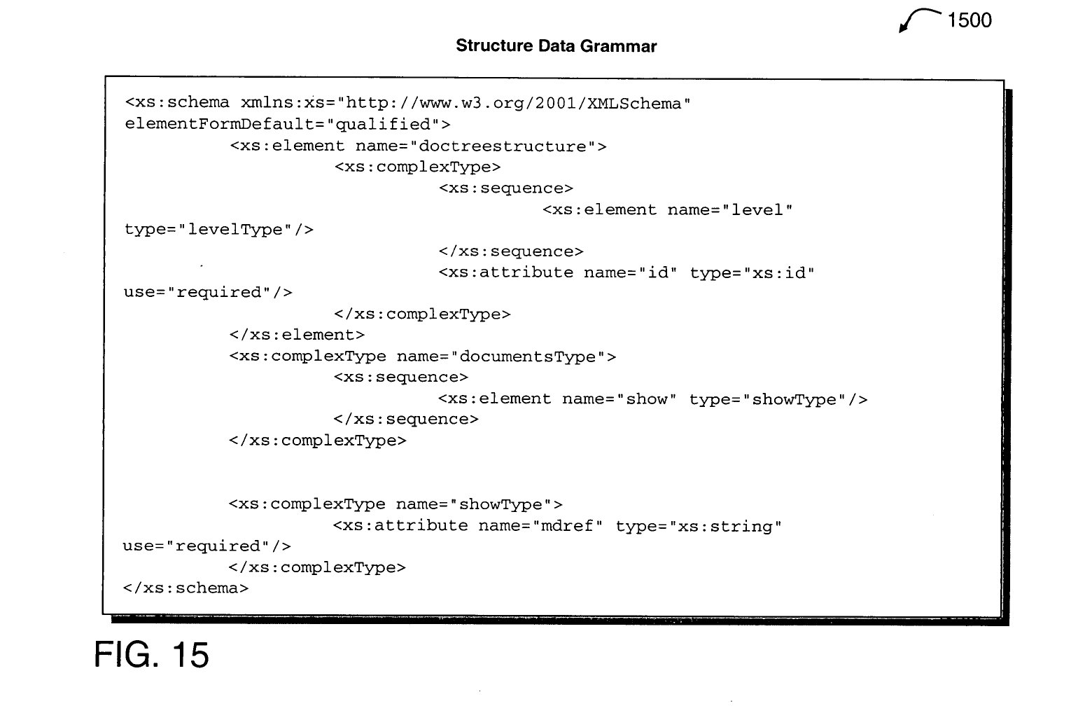

Another embodiment of the present inventive system and method is illustrated in FIG. 15. FIG. 15 is an illustration of a structure data grammar code fragment in accordance with a preferred embodiment of the invention. Structure data grammar code fragment 1500 includes schema declarations which include element declarations and which include element types. According to an embodiment of the present invention the metadata grammar can be a DTD or an XML schema.

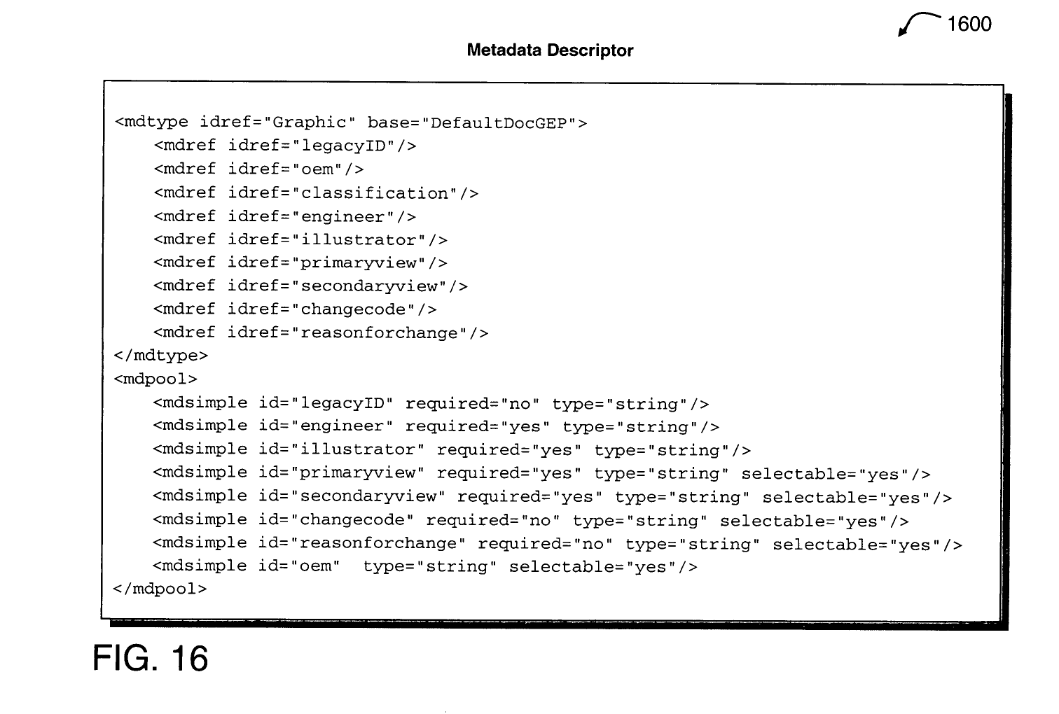

Another embodiment of the present inventive system and method is illustrated in FIG. 16. FIG. 16 is an illustration of a metadata descriptor code fragment in accordance with a preferred embodiment of the invention.

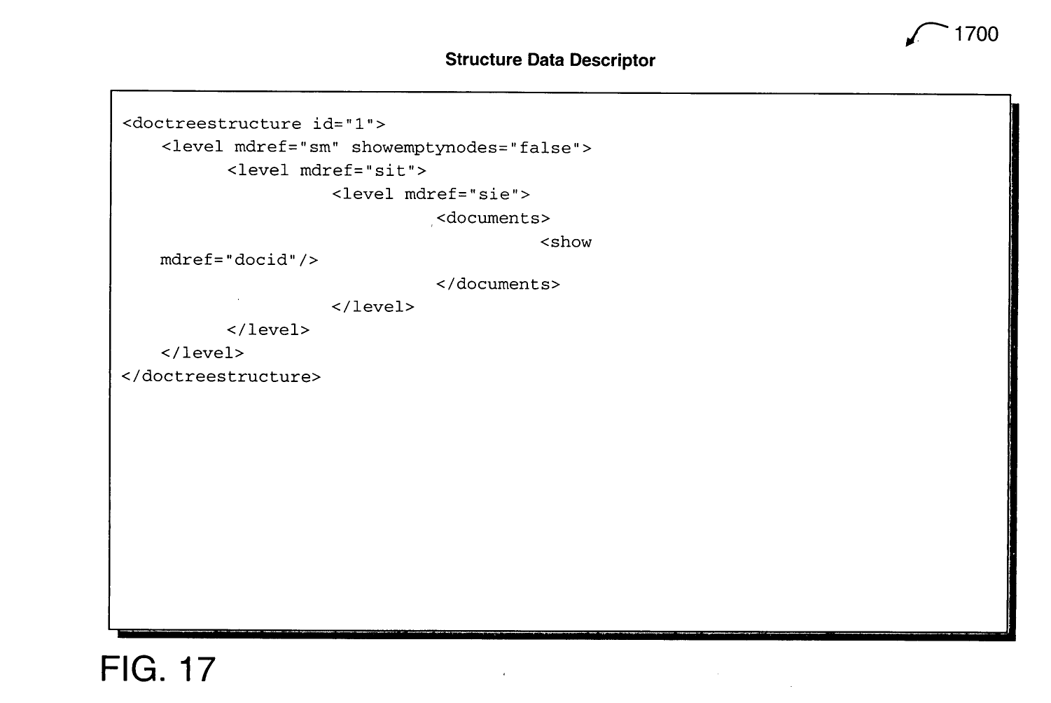

Another embodiment of the present inventive system and method is illustrated in FIG. 17. FIG. 17 is an illustration of a structure data descriptor code fragment in accordance with a preferred embodiment of the invention. The structure data code 1700 includes a view definition.

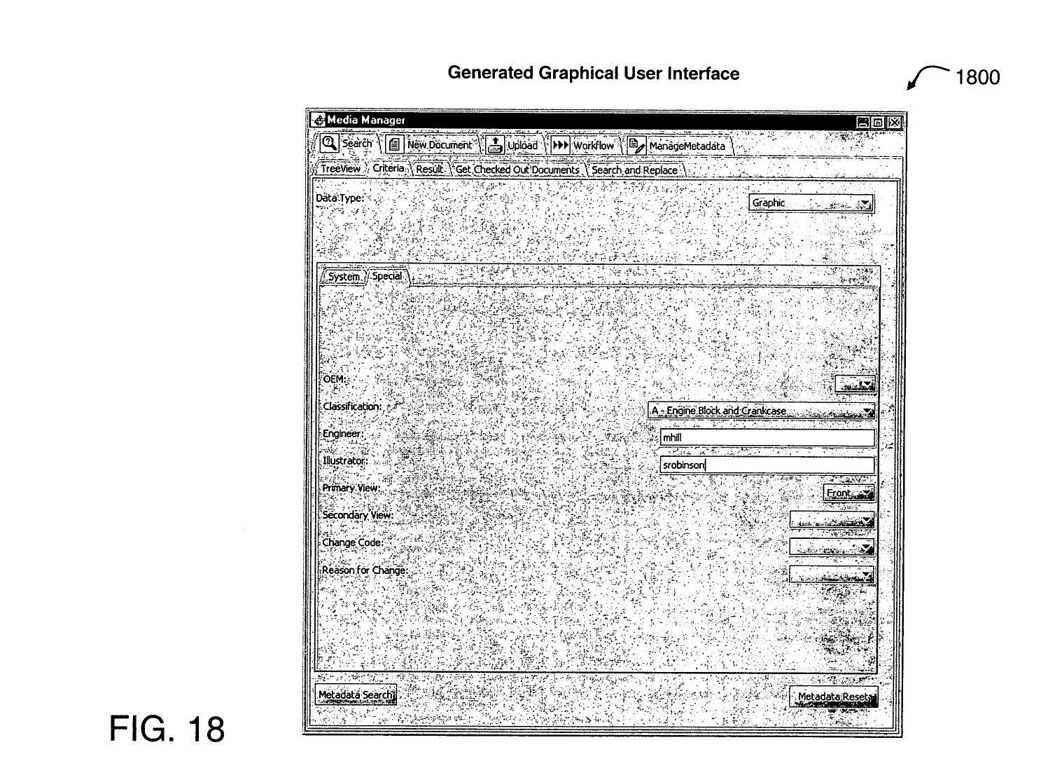

Another embodiment of the present inventive system and method is illustrated in FIG. 18. FIG. 18 is an illustration of a graphical user interface in accordance with a preferred embodiment of the invention.

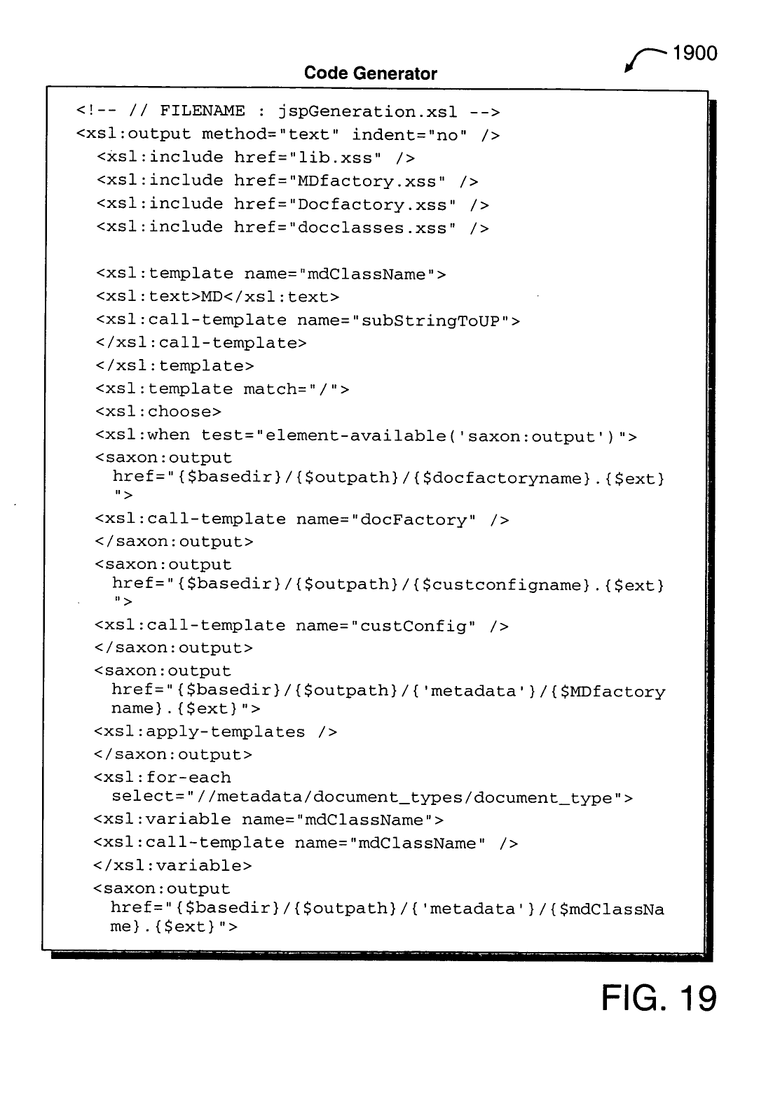

FIG. 19 is an illustration of a code generator code fragment in accordance with a preferred embodiment of the invention. FIG. 19 is an illustration of a code generator code fragment in accordance with a preferred embodiment of the invention. The generator code 1900 includes a fragment of a code generator implemented using XSL.

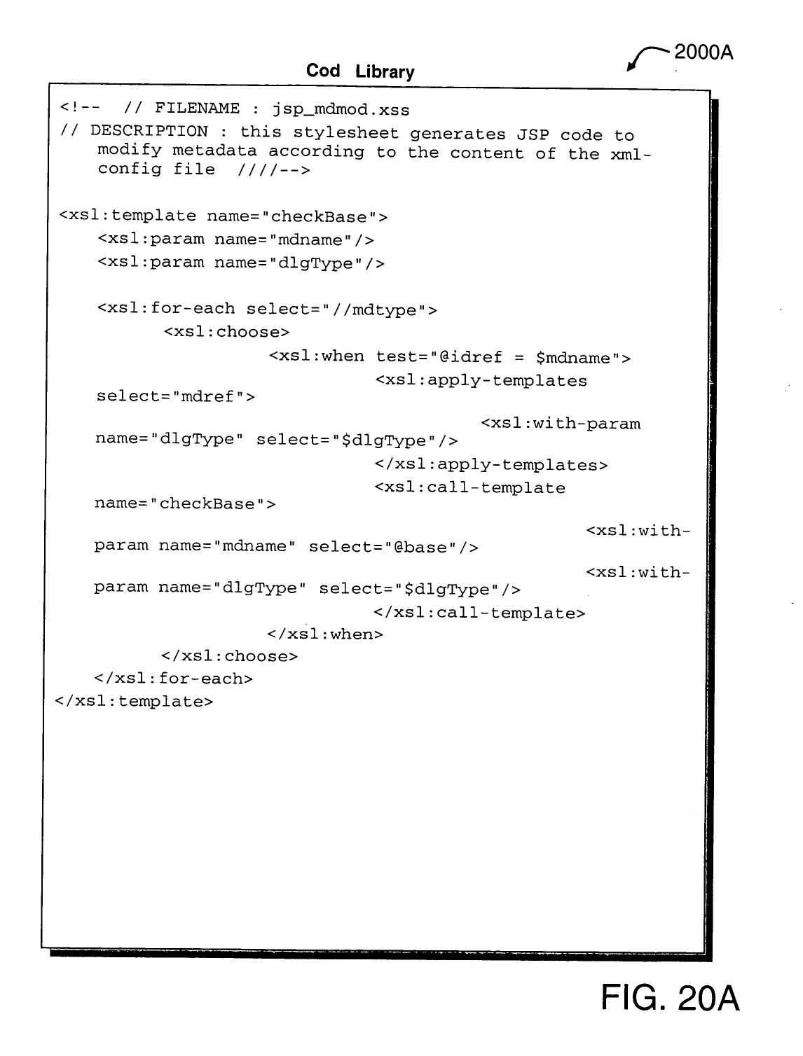

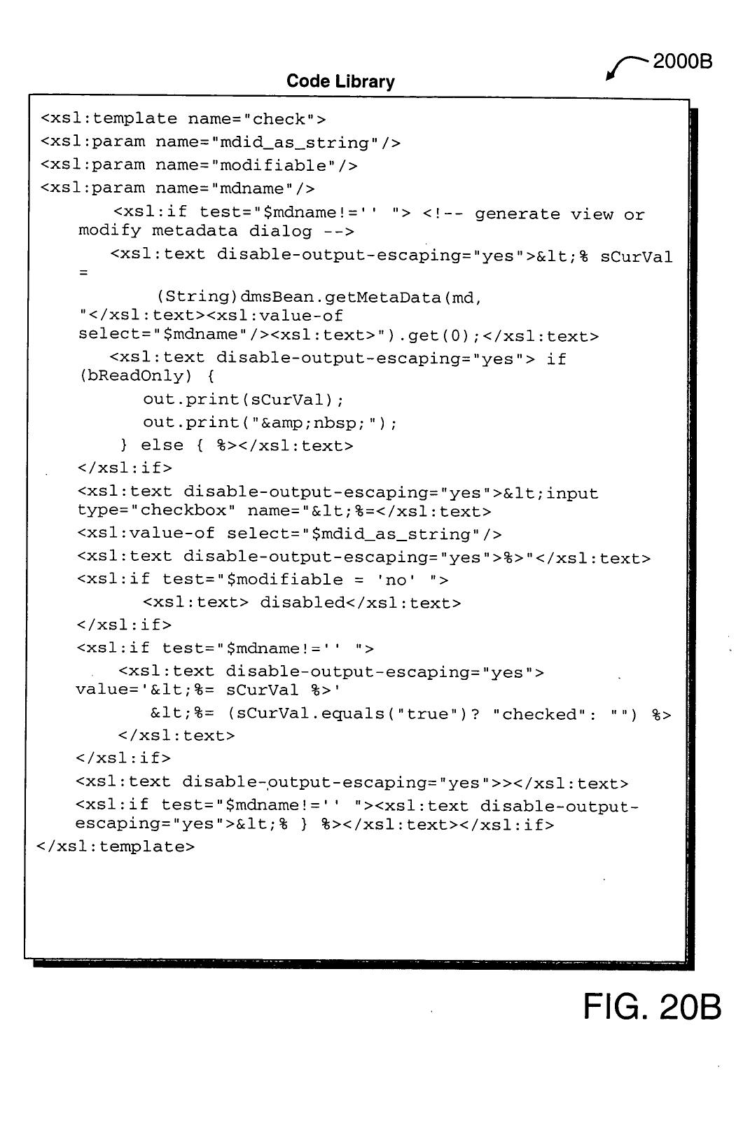

FIGS. 20A and 20B are an illustration of a code library code fragment in accordance with a preferred embodiment of the invention. FIG. 20A is an illustration of a code library code fragment in accordance with a preferred embodiment of the invention. The code library 2000A includes a first portion of a code library code fragment which has been implemented using an XML stylesheet. FIG. 20B is an illustration of a second portion of code library 2000A as shown in FIG. 20A. The code library 2000B includes a second portion of a code library code fragment of FIG. 20A which has been implemented using an XML stylesheet.

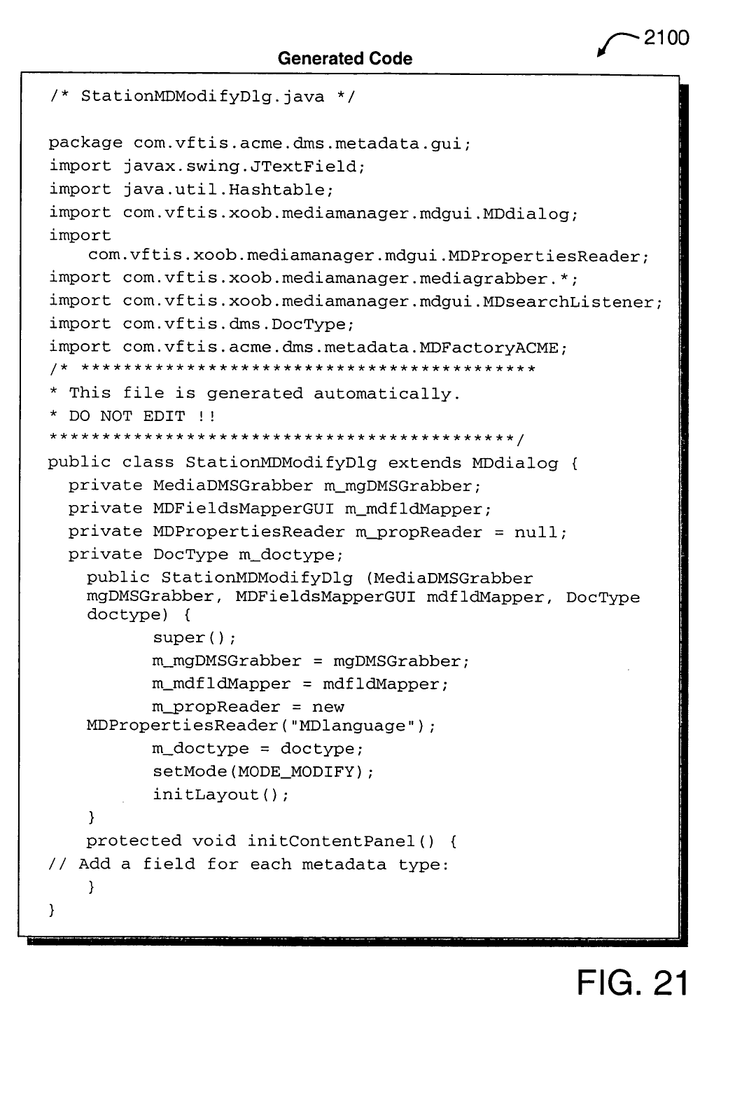

FIG. 21 is an illustration of a generated code fragment in accordance with a preferred embodiment of the invention. FIG. 21 includes generated code java fragment 2100.

According to one embodiment of the present invention, the method is implemented as a computer program, namely, as a set of instructions executed by a processor. Thus, for example, the method may be a Java applet, a browser plug-in, a standalone application written in native code, a distinct process built into the web browser, or part of the integral web browser functionality. One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A system for content structure adaptation comprising:
a grammar specification that defines a set of rules for the system;
a descriptor that defines content names and types, wherein said descriptor creates an instance based upon said grammar specification;
an interpreter that adds system requirements to said instance; and
a code generator that generates application code in response to the system requirements defined in said instance.

2. The system as in claim 1, further comprising:
a code library that provides application code fragments to said code generator.

3. The system as in claim 1, wherein said code generator further comprises:
a processing code generator that generates application code for processing system objects; and
a graphical user interface code generator that generates application code for a graphical user interface.

4. The system as in claim 1, wherein said grammar specification further comprises:
a metadata grammar specification that defines a set of metadata rules for the system; and
a structure data grammar specification that defines a set of structure data rules for the system.

5. The system as in claim 1, wherein said descriptor further comprises:
a metadata descriptor that defines metadata names and types; and
a structure data descriptor that defines structure data names and types.

6. The system as in claim 1, wherein said interpreter further comprises:
a metadata interpreter that adds system metadata requirements to said instance; and
a structure data interpreter that adds system structure data requirements to said instance.

7. The system as in claim 1, further comprising:
a code library that provides application code fragments to said code generator; and
wherein said code generator further comprises:
a processing code generator that generates application code for processing system objects; and
a graphical user interface code generator that generates application code for a graphical user interface.

8. A system for content structure adaptation comprising:
a metadata grammar specification that defines a set of metadata rules for the system;
a structure data grammar specification that defines a set of structure data rules for the system;
a metadata descriptor that defines metadata names and types, wherein said metadata descriptor creates a metadata instance based upon said metadata grammar specification;
a structure data descriptor that defines structure data names and types, wherein said structure data descriptor creates a structure data instance based upon said structure data grammar specification;
a metadata interpreter that adds system metadata requirements to said metadata instance;
a structure data interpreter that adds system structure data requirements to said structure data instance;
a metadata processing code generator that generates application code for processing system metadata objects in response to the system requirements defined in said metadata instance;
a structure data processing code generator that generates application code for processing system structure data objects in response to the system requirements defined in said structure data instance; and
a graphical user interface code generator that generates application code for a graphical user interface code objects in response to the system requirements defined in said metadata instance and said structure data instance.

9. The system as in claim 8, further comprising:
a code library that provides application code fragments to said metadata processing code generator.

10. The system as in claim 8, further comprising:
a code library that provides application code fragments to said structure data processing code generator.

11. The system as in claim 8, further comprising:
a code library that provides application code fragments to said graphical user interface code generator.

12. The system as in claim 8, further comprising:
a code library that provides application code fragments to said graphical user interface code generator, said metadata processing code generator and said structure data processing code generator.

13. A method for content structure adaptation, comprising:
deriving a data element description from common data;
applying system rules including data rules and system requirements to said data element description to create an instance that includes data element definitions and system data requirements; and
mapping said data element definitions to corresponding source code fragments in response to said system data requirements.

14. A method for content structure adaptation, comprising:
deriving a structure data element description from common structure data;
applying system rules including structure data rules and system requirements to said structure data element description to create an instance that includes structure data element definitions and system structure data requirements; and
mapping said structure data element definitions to corresponding source code fragments in response to said system structure data requirements.

15. The method of 14 further comprising:
deriving a metadata element description from common metadata;
applying system rules including metadata rules and system requirements to said metadata element description to create an instance that includes metadata element definitions and system metadata requirements; and
mapping said metadata element definitions to corresponding source code fragments in response to said system metadata requirements.

16. A system for content structure adaptation, comprising:
means for deriving a data element description from common data;
means for applying system rules including data rules and system requirements to said data element description to create an instance that includes data element definitions and system data requirements; and
means for mapping said data element definitions to corresponding source code fragments in response to said system data requirements.

17. A system for content structure adaptation, comprising:
means for deriving a structure data element description from common structure data;
means for applying system rules including structure data rules and system requirements to said structure data element description to create an instance that includes structure data element definitions and system structure data requirements; and
means for mapping said structure data element definitions to corresponding source code fragments in response to said system structure data requirements.

18. The system as in claim 17 further comprising:
means for deriving a metadata element description from common metadata;
means for applying system rules including metadata rules and system requirements to said metadata element description to create an instance that includes metadata element definitions and system metadata requirements; and
means for mapping said metadata element definitions to corresponding source code fragments in response to said system metadata requirements.

19. A computer readable recording medium having embodied thereon a program enabling a computer to provide a service for content structure adaptation, the service comprising:
deriving a data element description from common data;
applying system rules including data rules and system requirements to said data element description to create an instance that includes data element definitions and system data requirements; and
mapping said data element definitions to corresponding source code fragments in response to said system data requirements.

20. A computer readable recording medium having embodied thereon a program enabling a computer to provide a service for content structure adaptation, the service comprising:
deriving a structure data element description from common structure data;
applying system rules including structure data rules and system requirements to said structure data element description to create an instance that includes structure data element definitions and system structure data requirements; and
mapping said structure data element definitions to corresponding source code fragments in response to said system structure data requirements.

21. The computer readable recording medium as in claim 20, the service for content structure adaptation further comprising:
deriving a metadata element description from common metadata;
applying system rules including metadata rules and system requirements to said metadata element description to create an instance that includes metadata element definitions and system metadata requirements; and
mapping said metadata element definitions to corresponding source code fragments in response to said system metadata requirements.
